(19) United States
(12) Patent Application Publication
(10) Pub. No.: US 2010/0185325 A1
(43) Pub. Date: Jul. 22, 2010

(54) Apparatus and method for controlling multi-axis robot

(75) Inventor: Young Do Kwon, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/656,192

(22) Filed: Jan. 20, 2010

(30) Foreign Application Priority Data
Jan. 21, 2009 (KR) 10-2009-5102

(51) Int. Cl. G06F 19/00

(52) U.S. Cl. 700/245

(57) ABSTRACT

An apparatus and method for controlling a multi-axis robot are disclosed. An upper controller generates control commands corresponding to a plurality of actuators mounted to axes of a multi-axis robot, and transmits the control commands to servo-controllers over a network. The servo-controllers transmit control commands to the plurality of actuators, and transmit sensor information acting as measurement data indicating status information of the actuators to the upper controller.

### CROSS-REFERENCE TO RELATED APPLICATIONS

This application claims the benefit of Korean Patent Application No. 2009-0005102, filed on Jan. 21, 2009 in the Korean Intellectual Property Office, the disclosure of which is incorporated herein by reference.

### BACKGROUND

1. Field

Embodiments relate to an apparatus and method for controlling a multi-axis robot in order to improve a controller of the multi-axis robot.

2. Description of the Related Art

Generally, a humanoid robot has a joint or articular structure similar to that of a human being. The humanoid robot may be, for example, a multi-axis robot which moves its own legs, arms, and hands to carry out a given task or work.

The humanoid robot has a plurality of servo-controllers driving and controlling actuators, such as motors, mounted to respective axes. For example, one servo-controller to control legs of the robot includes firmware and a control algorithm, which are suitable to control torque. Another servo-controller to control hands or arms of the robot includes firmware and a control algorithm, which are suitable to control the robot position. Performance of a servo-controller is decided according to a performance of a servo-control algorithm implemented on each axis. The servo-controllers may perform individual gain-tuning operations according to characteristics of a corresponding motor, and may perform their-specified servo-control algorithms.

An upper controller of the robot transmits a control command to individual servo-controllers, and the servo-controllers execute robot operations according to the control command. When controlling the robot operations, a central processing unit (CPU) of each servo-controller mainly performs the control command. The CPU of the servo-controller transmits the control command of the upper controller to a terminal hardware (i.e., the lowest-level hardware), and manages a communication function to transmit sensor information measured by sensor(s) to the upper controller in order to determine whether the transmitted control command is correctly carried out. Specifically, in order to use a torque-control algorithm to control a motor torque in real time and a high-performance servo-control algorithm to control the motor speed or position, the CPU to process the high-speed operation and the high-communication process is requisite for a multi-axis robot.

When improving performances of the individual servo-controllers or updating the firmware or control algorithm of the corresponding controller in the multi-axis robot, the multi-axis robot may additionally have a management program to maintain/manage the firmware and control algorithm mounted to the CPU of each servo-controller, and management programs used for respective servo-controllers may be replaced with others or be corrected, respectively, resulting in greater inconvenience of use.

### SUMMARY

Therefore, it is an aspect to provide an apparatus and method for controlling a multi-axis robot, which may simplify a hardware configuration of a controller simultaneously while easily maintaining/managing the hardware configuration.

Additional aspects will be set forth in part in the description which follows and, in part, will be apparent from the description, or may be learned by practice of the embodiments.

The foregoing and/or other aspects may be achieved by providing an apparatus for controlling a multi-axis robot including a plurality of actuators connected to the multi-axis robot, a plurality of servo-controllers to drive the plurality of actuators, respectively, and an upper controller to generate control commands corresponding to the plurality of actuators, and transfer the control commands to the plurality of servo-controllers.

The upper controller may include a central processing unit (CPU) to manage a firmware and control algorithm corresponding to the plurality of actuators.

The CPU of the upper controller may include a unified management program to improve a function of a desired one of the servo-controllers or update the firmware or control algorithm.

The actuator may be a motor mounted to each robot axis.

The apparatus may further include a network to interconnect the plurality of servo-controllers and the upper controller, and a sensor unit to measure a driving status of a motor, wherein each of the servo-controllers includes a logic unit to transmit not only the control command received over the network but also sensor information measured by the sensor unit.

Each of the servo-controllers may further include a communication module and a motor driver, and the logic unit may include an interface logic, which transmits data received from the communication module to the motor driver or transmits other data received from the motor driver to the communication module.

The interface logic may include a plurality of registers which transmit command data corresponding to the control command and feedback data corresponding to the sensor information.

The foregoing and/or other aspects may also be achieved by providing a method for controlling a multi-axis robot includes generating, by an upper controller, control commands corresponding to a plurality of actuators, transmitting the generated control commands to servo-controllers corresponding to the plurality of actuators, and transmitting, by each of the servo-controllers, the control commands corresponding to a corresponding actuator, and transmitting sensor information measured by a sensor unit used for measuring status information of the plurality of actuators to the upper controller.

Each of the actuators may be a motor mounted to a robot axis, and the control commands may be generated from a central processing unit (CPU) of the upper controller using firmware and control algorithms corresponding to the plurality of motors.

Each of the servo-controllers may temporarily store predetermined-sized data, and may transmit predetermined amount of data after being filled with this predetermined amount of data.

### BRIEF DESCRIPTION OF THE DRAWINGS

These and/or other aspects will become apparent and more readily appreciated from the following description of the embodiments, taken in conjunction with the accompanying drawings of which:

FIG. 1 is a block diagram illustrating an apparatus controlling a multi-axis robot according to an exemplary embodiment;

FIG. 2 is a block diagram illustrating elements shown in FIG. 1;

FIG. 3 is a block diagram illustrating a data transmission operation of the servo-controller of FIG. 2 according to an exemplary embodiment;

FIG. 4 is a flow chart illustrating a method for controlling a multi-axis robot according to an exemplary embodiment;

FIG. 5 is a flow chart illustrating an operation transmitting command data according to an exemplary embodiment; and

FIG. 6 is a flow chart illustrating an operation transmitting feedback data according to an exemplary embodiment.

### DETAILED DESCRIPTION OF EMBODIMENTS

Reference will now be made in detail to the embodiment, examples of which are illustrated in the accompanying drawings, wherein like reference numerals refer to like elements throughout.

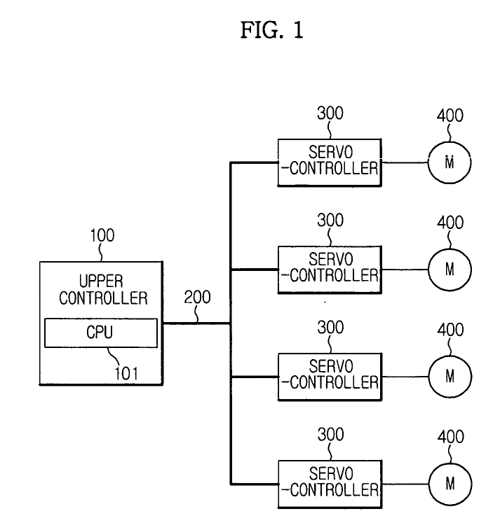

Referring to FIG. 1, an apparatus to control a multi-axis robot includes an upper controller 100 and a plurality of servo-controllers 300. The upper controller 100 and the servo-controllers 300 are connected to each other over a network 200. The servo-controllers 300 drive and control motors 400, respectively. The motors 400 are connected to legs, arms, hands, and feet of a robot, respectively. The servo-controllers 300 may use a torque control method or a position control method, and therefore may be similar to those of conventional servo-controllers.

In order to follow control commands between the upper controller 100 and the individual servo-controllers 300, and the result of the control commands, sensor information measured by sensors is transferred over the network 200 in real time. Although the network 200 is implemented with the Ethernet-supporting high-speed communication in the above-mentioned example, the scope of the network 200 is not limited to only the Ethernet, and a communication protocol transmitting high-capacity data to a position between the upper controller 100 and each servo-controller 300 in real time may also be used for the above example.

The upper controller 100 provides execution-purposed control commands which are immediately executed in each servo-controller 300. In this case, the execution-purposed control commands may allow the servo-controllers 300 to drive their motors without using a control algorithm. As a result, the central processing unit (CPU) 101 may be excluded from each servo-controller 300.

The upper controller 100 may include a firmware corresponding to each servo-controller 300 and a high-performance CPU 101 managing the control algorithm. This CPU 101 includes a unified management program, which may improve functions of the servo-controllers 300 or update the firmware and the control algorithm. Therefore, by the unified management program provided from the upper controller 100, the firmware and the control algorithm of a desired one of the servo-controllers 300 may be easily replaced or corrected by a user.

Each servo-controller 300 receives the execution-purposed control command from the upper controller 100, and drives the motor 400 through a series of data relay processes.

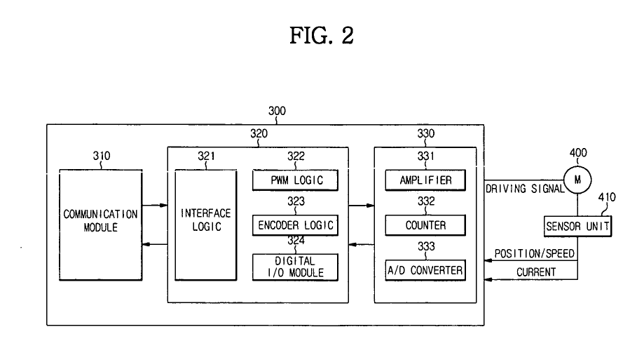

As shown in FIG. 2, each servo-controller 300 transmits a driving signal to its motor 400, a variety of measurement values (e.g., a motor position, speed, and current) measured by a sensor unit 410. The servo-controller 300 includes a communication module 310 connected to the network 200, a logic unit 320 communicating with the communication module 310, and a motor driver 330 driving the motor. The logic unit 320 includes an interface logic 321, a pulse width modulation (PWM) logic 322, an encoder logic 323, and a digital input/output (I/O) module 324.

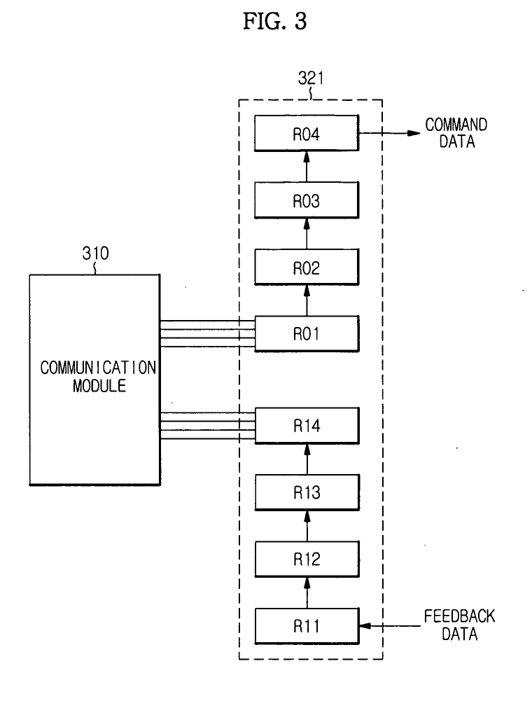

The communication module 310 is connected to the network 200 such that it receives control commands from the upper controller 100. The control commands are digitally converted into command data, such that the command data is then transferred to the logic unit 320. The interface logic 321 of the logic unit 320 temporarily stores the command data received from the communication module 310, and then transmits the stored command data to the PWM logic 320. The operation to transmit the above command data will be described with reference to FIG. 3. The PWM logic 320 transmits the driving signal, which has been PWM-processed by the above command data, to the motor driver 330. This driving signal is amplified to a proper level by an amplifier 331 of the motor driver 330, and the amplified driving signal is applied to the motor 400, such that the motor 400 is driven and the motor speed is changed to another speed. If the motor is driven, the sensor unit 410 measures the motor position, speed and current using the encoder, and provides the motor driver 330 with the measured position, speed, and current of the motor.

A counter 332 of the motor driver 330 changes the measurement value of the motor position or speed to another signal, such that the changed result is transmitted to the encoder logic 323 of the logic unit 320. The ND converter 333 of the motor driver 330 converts the measurement value of the motor current into a digital current value, and provides the encoder logic 323 with the digital current value. The encoder logic 323 counts the motor position or speed, transmits feedback data corresponding to each counted value to the interface logic 321, and transmits more feedback data corresponding to the motor current value to the interface logic 321. The interface logic 321 temporarily stores the above feedback data in a plurality of registers, and transmits the stored feedback data to the communication module 310.

The digital I/O module 324 takes charge of data I/O operations of the logic unit 320.

The interface logic 321 of the logic unit 320 is connected between the communication module 310 and the motor driver 330, such that data may be easily communicated between the communication module 310 and the motor driver 330 via the interface logic 321. A detailed description thereof will hereinafter be described in detail.

As shown in FIG. 3, the communication module 310 and the interface logic 321 are connected to each other, such that they may input or output data of 4 bits at high speed at one time. For example, when receiving data of the communication module 310, 4-bit command data provided from the communication module 310 is temporarily stored in a first output register R01. Command data of the first output register R01 is shifted to a second output register R02 at an input time of the next 4-bit command data, and at the same time new 4-bit command data is temporarily stored in the first output register R01. In this way, 4-bit command data may be sequentially filled in the first to fourth output registers R01, R02, R03, and R04, and then total 16-bit command data is transferred to the PWM logic unit 320.

As another example, 4-bit feedback data, which is used for a feedback to the upper controller 100 as sensor information measured by the sensor unit 410, is temporarily stored in the first input register R11. Feedback data of the first input register R11 is shifted to the second input register R12 at an input time of the next 4-bit feedback data, and at the same time new O-bit feedback data is temporarily stored in the first input register R11. In this way, 4-bit feedback data may be sequentially filled in the first to fourth input registers R11, R12, R13, and R14, and then total 16-bit feedback data is transferred to the communication module 310. The feedback data, i.e., sensor information, may be transferred to the upper controller 100 over the network 200. In this way, the upper controller 100 communicates with each servo-controller 300, such that the motor 400 mounted to each axis may be properly driven.

A method for controlling a multi-axis robot according to an exemplary embodiment will now be described in detail.

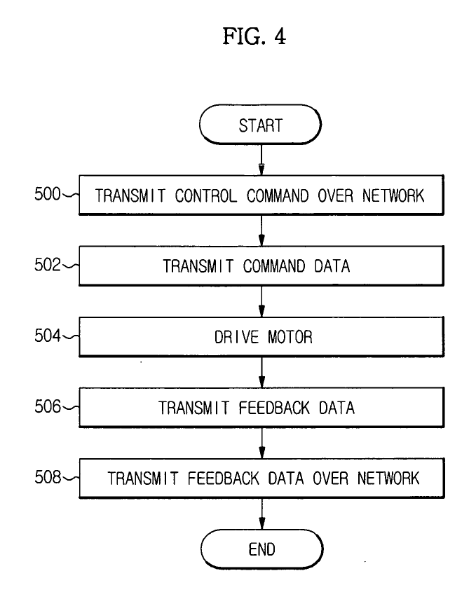

In FIG. 4, the upper controller 100 makes the execution-purposed control command for performing a task given to the robot, and transmits this execution-purposed control command to each servo-controller 300 over the network 200 at operation 500. In this case, the execution-purposed control command provided from the upper controller 100 may allow the servo-controller 300 to drive its motor without using the control algorithm.

The communication module 310 of the servo-controller 300 converts the control command of the upper controller 100 into command data, and transmits the command data to the interface logic 321 of the logic unit 320 at operation 502.

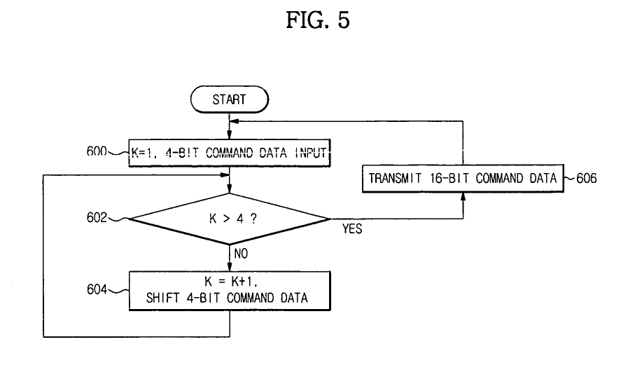

In FIG. 5, the interface logic 321 receives first 4-bit command data via the communication module 310, and temporarily stores the received 4-bit command data in the first output register R01 at operation 600. If the first to fourth output registers R01, R02, R03, and R04 are not filled with the command data at operation 602, the first 4-bit command data is shifted to the second output register R02, and at the same time the next 4-bit command data is temporarily stored in the first output register R01 at operation 604. Otherwise, if the first to fourth output registers R01, R02, R03, and R04 are filled with the command data at operation 602 by repetition of the above operation, total 16-bit command data is transferred to the PWM logic 322 at operation 606. Then, after performing the operation 606, the control program of the multi-axis robot returns to the above operation 600, such that transmission of the command data is continued at operation 600. Command data of the upper controller 100 is PWM-processed by the PWM logic 320, the PWM-processed result is amplified by the amplifier 331, and the amplified PWM result is applied to the motor 400, such that the motor is driven at operation 504.

The measurement value of the motor position or speed is provided from the sensor unit 410, and is then changed to a signal being counted by the counter 332, such that this signal is transferred to the encoder logic 323. The measurement value of the motor current is converted into a digital current value by the ND converter, and this digital current value is provided to the encoder logic 323. The encoder logic 323 counts the motor position or speed, transmits feedback data corresponding to the counted position of the motor to the interface logic 321, and at the same time transmits another feedback data corresponding to the counted speed of the motor to the interface logic 321. The interface logic 321 temporarily stores the above feedback data in a plurality of registers, and transmits the stored feedback data to the communication module 310 at operation 506.

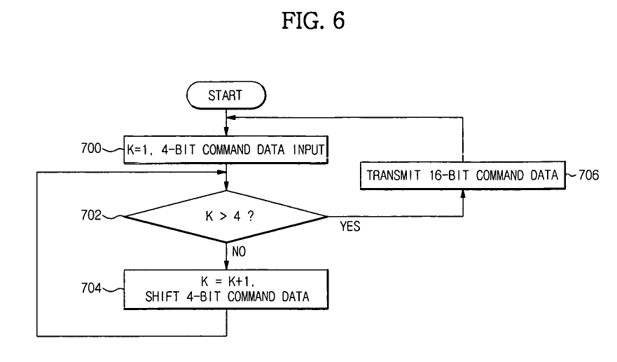

Referring to FIG. 6, the first 4-bit feedback data to be transmitted as sensor information measured by the sensor unit 410 to the upper controller 100 is temporarily stored in the first input register R11 at operation 700. If the first to fourth input registers R11, R12, R13, and R14 are not filled with the feedback data at operation 702, the first 4-bit feedback data is shifted to the second input register R12, and at the same time the next 4-bit feedback data is temporarily stored in the first input register R11 at operation 704. Otherwise, if the first to fourth input registers R11, R12, R13, and R14 are completely filled with the feedback data at operation 702 by repetition of the above operation, total 16-bit feedback data is transferred to the communication module 310.

The communication module 310 transmits the feedback data to the upper controller 100 over the network 200 at operation 508. In this way, the upper controller 100 communicates with each servo-controller 300, such that the motor 400 mounted to each axis may be properly driven.

As is apparent from the above description, the above embodiment removes the CPU from each servo-controller of the multi-axis robot, such that it may easily implement the individual servo-controllers. Also, the embodiment may allow the upper controller to improve the function of each servo-controller or update the firmware or the control algorithm at one time, thereby easily maintaining/managing the individual controllers.

Although a few embodiments have been shown and described, it would be appreciated by those skilled in the art that changes may be made in these embodiments without departing from the principles and spirit of the embodiments, the scope of which is defined in the claims and their equivalents.

What is claimed is:

1. An apparatus controlling a multi-axis robot, the apparatus comprising:
a plurality of actuators connected to the multi-axis robot;
a plurality of servo-controllers to drive the plurality of actuators, respectively; and
an upper controller to generate control commands corresponding to the plurality of actuators, and transfer the control commands to the plurality of servo-controllers.

2. The apparatus according to claim 1, wherein the upper controller includes a central processing unit (CPU) to manage a firmware and control algorithm corresponding to the plurality of actuators.

3. The apparatus according to claim 2, wherein the CPU of the upper controller includes a unified management program to improve a function of a desired one of the servo-controllers or update the firmware or control algorithm.

4. The apparatus according to claim 1, wherein the actuators are motors mounted to robot axes, respectively.

5. The apparatus according to claim 2, further comprising:
a plurality of motors respectively driven by the servo controllers;
a network to interconnect the plurality of servo-controllers and the upper controller, and a sensor unit to measure a driving status of at least one of the motors,
wherein each of the servo-controllers includes a logic unit to transmit the control command received over the network and sensor information measured by the sensor unit.

6. The apparatus according to claim 5, wherein each of the servo-controllers further includes a communication module and a motor driver, and the logic unit includes an interface logic, which transmits data received from the communication module to the motor driver or transmits another data received from the motor driver to the communication module.

7. The apparatus according to claim 6, wherein the interface logic includes a plurality of registers which transmit command data corresponding to the control command and feedback data corresponding to the sensor information.

8. A method for controlling a multi-axis robot, the method comprising:
generating, by an upper controller, control commands corresponding to a plurality of actuators;
transmitting the generated control commands to servo-controllers corresponding to the plurality of actuators; and
transmitting, by each of the servo-controllers, the control commands corresponding to a corresponding actuator, and transmitting sensor information measured by a sensor unit used for measuring status information of the plurality of actuators to the upper controller.

9. The method according to claim 8, wherein each of the actuators is a motor mounted to a robot axis, and the generating the control commands comprises generating the control commands from a central processing unit (CPU) of the upper controller using firmware and control algorithms corresponding to the plurality of motors.

10. The method according to claim 9, wherein each of the servo-controllers temporarily stores predetermined-sized data, and transmits a predetermined amount of data after being filled with the predetermined size of data.
